(19) United States
(12) Patent Application Publication
(10) Pub. No.: US 2023/0039685 A1
(43) Pub. Date: Feb. 9, 2023

(54) NONAQUEOUS ELECTROLYTE FOR SECONDARY BATTERIES AND NONAQUEOUS ELECTROLYTE SECONDARY BATTERY

(71) Applicant: SANYO Electric Co., Ltd., Kodoma-shi,Osaka (JP)

(72) Inventors: Makoto Kubo, Mie (JP); Kazunori Donoue, Hyogo (JP); Shinya Miyazaki, Hyogo (JP)

(73) Assignee: SANYO Electric Co., Ltd., Kadoma-shi, Osaka (JP)

(21) Appl. No.: 17/794,059

(22) PCT Filed: Jan. 19, 2021
(86) PCT No.: PCT/JP2021/001684

§ 371 Date: Jul. 20, 2022

(30) Foreign Application Priority Data
Jan. 28, 2020 (JP) 2020-011291

(51) Int. Cl. H01M 10/0569; H01M 10/0525

(52) U.S. Cl. CPC H01M 10/0569; H01M 10/0525; H01M 2300/0037

(57) ABSTRACT

This nonaqueous electrolyte secondary battery is provided with a positive electrode, a negative electrode, and a nonaqueous electrolyte. The nonaqueous electrolyte contains a carboxylic acid ester and lithium bisoxalato borate. The concentration of the carboxylic acid ester is not less than 0.01% by volume but less than 10% by volume relative to the volume of the nonaqueous solvent. In addition, the concentration of the lithium bisoxalato borate is not less than 0.01 M but less than 0.2 M.

### TECHNICAL FIELD

The present disclosure relates to a non-aqueous electrolyte for a secondary battery and a non-aqueous electrolyte secondary battery for which the non-aqueous electrolyte is used.

### BACKGROUND

It is known in the art of non-aqueous electrolyte secondary batteries such as lithium ion batteries that non-aqueous electrolytes significantly affect the battery performance including input and output characteristics, capacity, and cycle characteristics. For example, Patent Literature 1 discloses a non-aqueous electrolyte secondary battery comprising a non-aqueous electrolyte that contains 3% to 30% by volume of a chain carboxylate ester relative to the volume of a non-aqueous solvent. Patent Literature 1 indicates that good low-temperature output characteristics are advantageously obtained.

### CITATION LIST

### Patent Literature

Patent Literature 1: International Publication No. WO 2016/084357

### SUMMARY

A non-aqueous electrolyte secondary battery may generate gas due to decomposition of a non-aqueous solvent during charging and discharging and may require gas venting. An increase in the amount of gas generation may cause problems such as swelling of the battery which is caused by gas and capacity reduction which is caused as gas is caught between electrodes. A carboxylate ester used in the non-aqueous electrolyte secondary battery disclosed in Patent Literature 1 has a high dielectric constant and a low viscosity and contributes to improved input and output characteristics, but tends to be reductively decomposed during initial charging. Therefore, the non-aqueous electrolyte secondary battery for which a carboxylate ester is used has a drawback in that it generates a large amount of gas.

According to the present disclosure, there is provided a non-aqueous electrolyte for a secondary battery, the non-aqueous electrolyte including a non-aqueous solvent, the non-aqueous electrolyte comprising a carboxylate ester; and lithium bis (oxalato)borate, wherein the concentration of the carboxylate ester is from 0.01% by volume to less than 10% by volume relative to the volume of the non-aqueous solvent, and wherein the concentration of the lithium bis (oxalato)borate is from 0.01 M to less than 0.2 M. The volume ratio herein is a value as measured at 25° C. and at one atmosphere.

According to the present disclosure, there is provided a non-aqueous electrolyte secondary battery comprising the above-described non-aqueous electrolyte, a positive electrode, and a negative electrode.

The non-aqueous electrolyte for a secondary battery according to the present disclosure enables reduction in the amount of gas generation in a non-aqueous electrolyte secondary battery for which a carboxylate ester is used. The non-aqueous electrolyte secondary battery comprising the non-aqueous electrolyte according to the present disclosure achieves good input and output characteristics with the amount of gas generation during initial charging being small.

### BRIEF DESCRIPTION OF DRAWINGS

FIG. 1 is a perspective view illustrating an outer appearance of a non-aqueous electrolyte secondary battery according to an example embodiment.

FIG. 2 is a perspective view of an electrode assembly according to an example embodiment.

### DESCRIPTION OF EMBODIMENTS

After diligent efforts to develop a non-aqueous electrolyte secondary battery that achieves good input and output characteristics with the amount of gas generation during initial charging being small, the present inventors have discovered that the intended battery performance is obtained by adding a carboxylate ester and lithium bis (oxalato)borate in specified amounts to a non-aqueous electrolyte. Although, as described above, a carboxylate ester, which contributes to improved input and output characteristics, tends to be reductively decomposed during initial charging, the non-aqueous electrolyte according to the present disclosure distinctively reduces gas generation.

An example embodiment of a non-aqueous electrolyte secondary battery according to the present disclosure will be described in detail below with reference to the drawings. Selective combinations of two or more of embodiments and modifications given by way of example below are envisioned from the beginning.

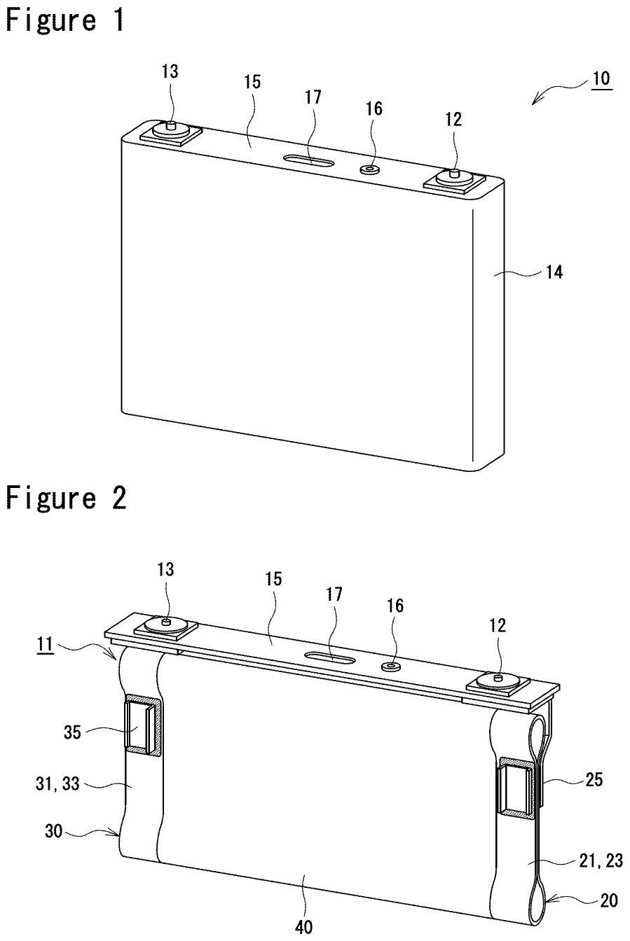

FIG. 1 is a perspective view illustrating an outer appearance of a non-aqueous electrolyte secondary battery 10 according to an example embodiment, and FIG. 2 is a perspective view of an electrode assembly 11 that is included in the non-aqueous electrolyte secondary battery 10. The non-aqueous electrolyte secondary battery 10 illustrated in FIG. 1 includes, as an outer housing, an outer can 14 having a rectangular tube shape with a closed bottom, but the outer housing is not limited to this example. The non-aqueous electrolyte secondary battery according to the present disclosure may be, for example, a cylindrical battery including an outer can having a cylindrical shape with a closed bottom, a coin-shaped battery including an outer can having a coin shape, and a laminate battery including an outer housing that is composed of a laminate sheet including a metal layer and a resin layer.

As illustrated in FIGS. 1 and 2, the non-aqueous electrolyte secondary battery 10 includes the electrode assembly 11, a non-aqueous electrolyte, the outer can 14 having a rectangular tube shape with a closed bottom for housing the electrode assembly 11 and the non-aqueous electrolyte, and a sealing plate 15 for closing an opening of the outer can 14. The non-aqueous electrolyte secondary battery 10 is what we call a rectangular battery. The electrode assembly 11 has a wound configuration in which a positive electrode 20 and a negative electrode 30 are wound with a separator 40 interposed therebetween. The positive electrode 20, the negative electrode 30, and the separator 40 are all elongated strip-shaped members, and the positive electrode 20 and the negative electrode 30 are wound with the separator 40 interposed therebetween. The electrode assembly may be a laminated electrode assembly that includes a plurality of positive electrodes and a plurality of negative electrodes alternately laminated one after another with a separator interposed therebetween.

The non-aqueous electrolyte secondary battery 10 includes a positive electrode terminal 12 that is electrically connected to the positive electrode 20 via a positive electrode current collector 25 and a negative electrode terminal 13 that is electrically connected to the negative electrode 30 via a negative electrode current collector 35. In the present embodiment, the sealing plate 15 has a long narrow rectangular shape with the positive electrode terminal 12 being disposed toward one end of the sealing plate 15 in the longitudinal direction, and the negative electrode terminal 13 being disposed toward another end of the sealing plate 15 in the longitudinal direction. The positive electrode terminal 12 and the negative electrode terminal 13 are external connection terminals that are electrically connectable to, for example, other non-aqueous electrolyte secondary batteries 10 or various electronic devices, and are attached to the sealing plate 15 with an insulating member interposed therebetween.

In the following description, for ease of description, the height direction of the outer can 14 is assumed to be the “vertical direction” of the non-aqueous electrolyte secondary battery 10, the term “upper” refers to the side toward the sealing plate 15, and the term“lower” refers to the side toward the bottom of the outer can 14. The direction along the longitudinal direction of the sealing plate 15 is assumed to be the “lateral direction” of the non-aqueous electrolyte secondary battery 10.

The outer can 14 is a metal container having a rectangular tube shape with a closed bottom. An opening that is formed in an upper end of the outer can 14 is closed off by, for example, welding the sealing plate 15 to the edge of the opening. The sealing plate 15 typically includes an injection member 16 for introducing a non-aqueous electrolyte solution, a gas release valve 17 that is opened for releasing gas when a failure occurs in the battery, and a current interruption mechanism. The outer can 14 and the sealing plate 15 are made of, for example, aluminum-based metallic material.

The electrode assembly 11 is a flat wound electrode assembly which includes a flat portion and a pair of curved portions. The electrode assembly 11 is housed in the outer can 14 with the winding axial direction being along the lateral direction of the outer can 14, and the width direction of the electrode assembly 11 where the pair of curved portions are aligned being along the height direction of the battery. In the present embodiment, a positive electrode side current collecting portion where a core exposed portion 23 of the positive electrode 20 is laminated is formed in one end of the electrode assembly 11 as viewed in the axial direction, a negative electrode side current collecting portion where a core exposed portion 33 of the negative electrode 30 is laminated is formed in another end of the electrode assembly 11 as viewed in the axial direction, and these current collecting portions are electrically connected to the terminals via the current collectors. An insulating electrode assembly holder (insulating sheet) may be provided between the electrode assembly 11 and the inside surface of the outer can 14.

[Positive Electrode]

The positive electrode 20 includes a positive electrode core 21 and a positive electrode mixture layer that is disposed on a surface of the positive electrode core 21. Examples of the positive electrode core 21 include foil of metal that is stable in an electric potential range of the positive electrode 20, such as aluminum or an aluminum alloy, and a film having such metal disposed in its surface layer. The positive electrode mixture layer contains a positive electrode active material, a conductive material, and a binder, and is preferably provided on both sides of the positive electrode core 21. The positive electrode 20 can be prepared by, for example, applying positive electrode mixture slurry containing, for example, a positive electrode active material, a conductive material, and a binder to the positive electrode core 21, drying the coating, and then compressing it to form positive electrode mixture layers on both sides of the positive electrode core 21.

A lithium transition metal composite oxide is used as the positive electrode active material. Examples of a metal element contained in the lithium transition metal composite oxide include Ni, Co, Mn, Al, B, Mg, Ti, V, Cr, Fe, Cu, Zn, Ga, Sr, Zr, Nb, In, Sn, Ta, and W. Among these, at least one of Ni, Co, and Mn is preferably contained. Examples of suitable composite oxides include a lithium transition metal composite oxide containing Ni, Co, and Mn, and a lithium transition metal composite oxide containing Ni, Co, and Al.

Examples of the conductive material contained in the positive electrode mixture layer include carbon materials such as carbon black, acetylene black, Ketjen black, and graphite. Examples of the binder contained in the positive electrode mixture layer include polytetrafluoroethylene (PTFE), polyvinylidene fluoride (PVdF), and other fluorocarbon resins, polyacrylonitrile (PAN), polyimide resins. acrylic resins, and polyolefin resins. One or more of these resins may be used in combination with, for example, a cellulose derivative such as carboxymethylcellulose (CMC) or a salt thereof, or polyethylene oxide (PEO).

[Negative Electrode]

The negative electrode 30 includes a negative electrode core 31 and a negative electrode mixture layer that is disposed on a surface of the negative electrode core 31. Examples of the negative electrode core 31 include foil of metal that is stable in an electric potential range of the negative electrode 30, such as copper, and a film having such metal disposed in its surface layer. The negative electrode mixture layer contains a negative electrode active material and a binder, and is preferably provided on both sides of the negative electrode core 31. The negative electrode 30 can be prepared by, for example, applying negative electrode mixture slurry containing, for example, a negative electrode active material, a conductive material, and a binder to the surface of the negative electrode core 31, drying the coating, and then compressing it to form negative electrode mixture layers on both sides of the negative electrode core 31.

As the negative electrode active material, the negative electrode mixture layer contains, for example, a carbon-based active material that reversibly occludes and releases lithium ions. A suitable carbon-based active material is, for example, graphite including natural graphite such as flake graphite, massive graphite, and earthy graphite, and artificial graphite such as massive artificial graphite (MAG) and graphitized mesophase carbon microbeads (MCMB). As the negative electrode active material, a Si-based active material that is composed of at least one of Si and a Si-containing compound may be used, and a carbon-based active material and a Si-based active material may be used in combination.

Similar to the positive electrode 20, examples of the conductive material contained in the negative electrode mixture layer include carbon materials such as carbon black, acetylene black, Ketjen black, and graphite. Similar to the positive electrode 20, examples of the binder contained in the negative electrode mixture layer include fluorocarbon resins, PAN, polyimides, acrylic resins, and polyolefins, and in a preferred embodiment, styrene-butadiene rubber (SBR) is used. In a preferred embodiment, the negative electrode mixture layer may further contain, for example, CMC or a salt thereof, polyacrylic acid (PAA) or a salt thereof, or polyvinyl alcohol (PVA). Among these, SBR is preferably used in combination with CMC or a salt thereof or PAA or a salt thereof.

[Separator]

A porous sheet having ion permeability and insulating properties is used as the separator 40. Specific examples of the porous sheet include a microporous thin film, woven fabric, and nonwoven fabric. Suitable examples of the material for the separator 40 include polyethylene, polypropylene, copolymers of ethylene and alpha olefins, and other polyolefins and cellulose. The separator 40 may have either a single-layer structure or a multi-layer structure. The separator 40 may have, on its surface, for example, a heat-resistant layer containing inorganic particles or a heat-resistant layer that is made of a high heat resistance resin such as an aramid resin, a polyimide, or a polyamideimide.

[Non-Aqueous Electrolyte]

The non-aqueous electrolyte includes a non-aqueous solvent and an electrolyte salt. Examples of the non-aqueous solvent include ethers, esters, nitriles such as acetonitrile, amides such as dimethylformamide, and mixed solvents of two or more thereof. The non-aqueous solvent may contain a halogen substitution product of these solvents in which hydrogens of the solvents are, at least in part, substituted with a halogen atom such as fluorine. Examples of the halogen substitution product include fluorinated cyclic carbonate esters such as fluoroethylene carbonate (FEC), fluorinated chain carbonate esters, and fluorinated chain carboxylate esters such as methyl fluoropropionate (FMP).

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the esters include cyclic carbonate esters such as ethylene carbonate (EC), propylene carbonate (PC), and butylene carbonate, and chain carbonate esters such as dimethyl carbonate (DMC), ethylmethyl carbonate (EMC), diethyl carbonate (DEC), methyl propyl carbonate, ethyl propyl carbonate, and methyl isopropyl carbonate. Among these, at least one selected from EC, EMC, and DMC is preferably used, and a mixed solvent of EC, EMC, and DMC is particularly preferably used. The content of EC is, for example, from 20% by volume to 30% by volume relative to the volume of the non-aqueous solvent. The content of EMC and DMC is, for example, from 30% by volume to 40% by volume relative to the volume of the non-aqueous solvent.

The non-aqueous solvent contains a carboxylate ester as an essential ingredient. The carboxylate ester may be a cyclic carboxylate ester such as γ-butyrolactone (GBL) or γ-valerolactone (GVL), but is preferably a chain carboxylate ester. The carboxylate ester is contained in an amount of from 0.01% by volume to less than 10% by volume relative to the volume of the non-aqueous solvent. By adding 0.01% by volume or more of a carboxylate ester, especially a chain carboxylate ester, to the non-aqueous electrolyte, the input and output characteristics of the battery are improved.

The content of the carboxylate ester is preferably 0.1% by volume or more, more preferably 0.5% by volume or more, and particularly preferably 1% by volume or more relative to the volume of the non-aqueous solvent. The maximum content of the carboxylate ester is preferably 8% by volume, more preferably 6% by volume, and particularly preferably 5% by volume relative to the volume of the non-aqueous solvent. If 10% by volume or more of a carboxylate ester is added, it is unlikely that the amount of gas generation will be reduced.

The chain carboxylate ester is preferably a compound having a carbon number of from 3 to 10. Specific examples of the chain carboxylate ester include methyl acetate, ethyl acetate, n-propyl acetate, isopropyl acetate, n-butyl acetate, isobutyl acetate, t-butyl acetate, methyl propionate, ethyl propionate, n-propyl propionate, isopropyl propionate, n-butyl propionate, isobutyl propionate, t-butyl propionate, methyl butyrate, ethyl butyrate, n-propyl butyrate, isopropyl butyrate, methyl isobutyrate, ethyl isobutyrate, n-propyl isobutyrate, and isopropyl isobutyrate. Among these, at least one selected from methyl acetate, ethyl acetate, methyl propionate, and ethyl propionate is preferable, and methyl acetate and methyl propionate are particularly preferable.

The non-aqueous electrolyte contains lithium bis (oxalato)borate (LiBOB) as an essential ingredient. The concentration of LiBOB in the non-aqueous electrolyte is from 0.01 M (mol/L) to less than 0.2 M. By adding 0.01 M or more of LiBOB to the non-aqueous electrolyte, the decomposition of the carboxylate ester is distinctively suppressed, and the amount of gas generation during initial charging is significantly reduced. The combined use of the carboxylate ester and LiBOB enables improved input and output characteristics of the battery and reduction in the amount of gas generation at the same time.

The concentration of LiBOB in the non-aqueous electrolyte is preferably 0.015 M or more, more preferably 0.018 M or more, and particularly preferably 0.020 M or more. The maximum concentration of LiBOB is preferably 0.15 M, more preferably 0.10 M, and particularly preferably 0.08 M. The effect of reducing the amount of gas generation is little even if LiBOB is added in a concentration of 0.2 M or more, and the excess amount of LiBOB will lower input and output characteristics.

The non-aqueous electrolyte preferably contains, in addition to LiBOB, another lithium salt as an electrolyte salt. Specific examples of the other lithium salt include LiBF₄, LiClO₄, LiPF₆, LiAsF₆, LiSbF₆, LiAlCl₄, LiSCN, LiFSO₃, LiCF₃SO₃, LiCF₃CO₂, Li(P(C₂O₄)F₄), Li(P(C₂O₄)₂F₂), Li(P(C₂O₄)₃), LiPF₆₋ₓ(CₙF₂ₙ₊₁)ₓ (where 1<x<6, and n is 1 or 2), LiB₁₀Cl₁₀, LiCl, LiBr, LiI, lithium chloroborane, lithium lower aliphatic carboxylates, and borates such as Li₂B₄O₇ and Li(B(C₂O₄)F₂). Among these, LiPF₆ is preferable. The concentration of LiPF₆ is preferably higher than the concentration of LiBOB.

A suitable example of the non-aqueous electrolyte contains the following ingredients:

<Non-Aqueous Solvent>

At least one of methyl acetate and methyl propionate in an amount of from 1% by volume to 5% by volume

EC in an amount of from 20% by volume to 30% by volume

EMC in an amount of from 30% by volume to 40% by volume

DMC in an amount of from 30% by volume to 40% by volume

<Lithium Salt>

LiBOB in an amount of from 0.02 M to 0.08 M

LiPF₆ in an amount of from 0.5 M to 1.5 M.

### EXAMPLES

The present disclosure will be further described below with reference to examples, but the present disclosure is not limited to these examples.

### Example 1

[Fabrication of Positive Electrode]

A lithium transition metal composite oxide represented by a general formula LiNi_{1/3}Co_{1/3}Mn_{1/3}O₂ was used as a positive electrode active material. The positive electrode active material, acetylene black, and polyvinylidene fluoride were mixed in a solid content mass ratio of 90:7:3, and N-methyl-2-pyrrolidone (NMP) was used as a dispersion medium to prepare positive electrode mixture slurry. Next, the positive electrode mixture slurry was applied to both sides of a positive electrode core composed of aluminum foil, and after the coating was dried and compressed, it is cut into pieces of a predetermined electrode size (50×234 mm), and then the coating was peeled off from the portion where an aluminum lead was to be attached, to obtain a positive electrode having positive electrode mixture layers on both sides of the positive electrode core.

[Fabrication of Negative Electrode]

Graphite was used as a negative electrode active material. The negative electrode active material, carboxymethylcellulose (CMC), and styrene-butadiene rubber (SBR) were mixed in a solid content mass ratio of 98:1:1, and water was used as a dispersion medium to prepare negative electrode mixture slurry. Next, the negative electrode mixture slurry was applied to both sides of a negative electrode core composed of copper foil, and after the coating was dried and compressed with a predetermined force, it is cut into pieces of a predetermined electrode size (52×330 mm), and then the coating was peeled off from the portion where a nickel lead was to be attached, to obtain a negative electrode having negative electrode mixture layers on both sides of the negative electrode core.

[Preparation of Non-Aqueous Electrolyte Solution]

Ethylene carbonate (EC), ethylmethyl carbonate (EMC), dimethyl carbonate (DMC), and methyl propionate (MP) were mixed in a volume ratio of 25:37:35:3 (at 25° C. and at one atmosphere). To this mixed solvent, LiPF₆ was added to achieve a concentration of 1.15 M and lithium bis (oxalato)borate (LiBOB) was added to achieve a concentration of 0.025 M to obtain a non-aqueous electrolyte solution.

[Fabrication of Test Cell]

An aluminum lead was attached to the core exposed portion of the above-described positive electrode, a nickel lead was attached to the core exposed portion of the above-described negative electrode, and the positive electrode and the negative electrode were spirally wound with a separator interposed therebetween and then pressed in the radial direction to prepare a flat wound electrode assembly. This electrode assembly was placed in an outer housing composed of an aluminum laminate sheet, the inside of the outer housing was filled with the above-described non-aqueous electrolyte, and then the opening of the outer housing was sealed to obtain a test cell (non-aqueous electrolyte secondary battery).

[Evaluation of Amount of Gas Generation]

After the volume of a test cell was measured by the Archimedes method, the test cell was subjected to aging treatment in which initial charging (CCCV charging to a battery voltage of 3.7 V) was performed under a temperature environment of 25° C. and in this charged state, the test cell was left at rest for 11 hours under a temperature environment of 75° C. After the aging treatment, the volume of the test cell was measured by the Archimedes method, and the amount of gas generation was calculated from the difference from the volume measured before the initial charging. The amount of gas generation is shown in Table 1 as a relative value assuming the amount of gas generation of a test cell in Reference Example 2 described below as 100 (the same applies to the following Examples and the like).

### Example 2

The amount of gas generation was evaluated using a test cell that was prepared in the same manner as in Example 1 except that in the formulation of the non-aqueous electrolyte solution, the concentration of LiPF₆ was changed to 0.9 M.

### Example 3

The amount of gas generation was evaluated using a test cell that was prepared in the same manner as in Example 2 except that in the formulation of the non-aqueous electrolyte solution, vinylene carbonate (VC) was added to achieve a concentration of 0.3 mass % relative to the mass of the non-aqueous electrolyte solution.

### Example 4

The amount of gas generation was evaluated using a test cell that was prepared in the same manner as in Example 2 except that in the formulation of the non-aqueous electrolyte solution, the concentration of LiBOB was changed to 0.04 M.

### Comparative Example 1

The amount of gas generation was evaluated using a test cell that was prepared in the same manner as in Example 2 except that in the formulation of the non-aqueous electrolyte solution, LiBOB was not added.

### Comparative Example 2

The amount of gas generation was evaluated using a test cell that was prepared in the same manner as in Comparative Example 1 except that in the formulation of the non-aqueous electrolyte solution, VC was added to achieve a concentration of 0.3 mass % relative to the mass of the non-aqueous electrolyte solution, MP was not added, and the volume ratio of EC, EMC, and DMC was 26:38:36.

### Comparative Example 3

The amount of gas generation was evaluated using a test cell that was prepared in the same manner as in Example 1 except that in the formulation of the non-aqueous electrolyte solution, LiBOB and MP were not added, and the volume ratio of EC, EMC, and DMC was 30:30:40.

### Reference Example 1

The amount of gas generation was evaluated using a test cell that was prepared in the same manner as in Example 1 except that in the formulation of the non-aqueous electrolyte solution, the concentration of LiBOB was changed to 0.07 M, MP was not added, and the volume ratio of EC, EMC, and DMC was 30:30:40.

### Reference Example 2

The amount of gas generation was evaluated using a test cell that was prepared in the same manner as in Reference Example 1 except that in the formulation of the non-aqueous electrolyte solution, the concentration of LiBOB was changed to 0.05 M, and VC was added to achieve a concentration of 0.3 mass % relative to the mass of the non-aqueous electrolyte solution.

TABLE 1

| | Non-aqueous Electrolyte (at 25° C. and at one atmosphere) | | | | | | | Performance Evaluation |
|---|---|---|---|---|---|---|---|---|
| | LiPF₆ | LiBOB | EC | EMC | DMC | MP | VC | Amount of Gas Generation |
| Example 1 | 1.15M | 0.025M | 25 vol % | 37 vol % | 35 vol % | 3 vol % | — | 100 |
| Example 2 | 0.9M | 0.025M | 25 vol % | 37 vol % | 35 vol % | 3 vol % | — | 119 |
| Example 3 | 0.9M | 0.025M | 25 vol % | 37 vol % | 35 vol % | 3 vol % | 0.3 wt % | 96 |
| Example 4 | 0.9M | 0.04M | 25 vol % | 37 vol % | 35 vol % | 3 vol % | — | 101 |
| Comparative | 0.9M | — | 25 vol % | 37 vol % | 35 vol % | 3 vol % | — | 297 |
| Example 1 | | | | | | | | |
| Comparative | 0.9M | — | 26 vol % | 38 vol % | 36 vol % | — | 0.3 wt % | 180 |
| Example 2 | | | | | | | | |
| Comparative | 1.15M | — | 30 vol % | 30 vol % | 40 vol % | — | — | 177 |
| Example 3 | | | | | | | | |
| Reference | 1.15M | 0.07M | 30 vol % | 30 vol % | 40 vol % | — | — | 101 |
| Example 1 | | | | | | | | |
| Reference | 1.15M | 0.05M | 30 vol % | 30 vol % | 40 vol % | — | 0.3 wt % | 100 |
| Example 2 | | | | | | | | |

As can be seen from Table 1, the amount of gas generation during initial charging in each of the test cells of the examples is significantly reduced when compared to the test cells of the comparative examples. Although MP, which is a carboxylate ester, and which contributes to improved input and output characteristics, tends to be reductively decomposed during initial charging, the test cells of the examples achieved a reduction in gas generation that is similar to or greater than those achieved by the test cells of the reference examples that do not contain MP. As the test cells of the reference examples do not contain MP they had inferior input and output characteristics when compared to the test cells of the examples.

### REFERENCE SIGNS LIST

10 non-aqueous electrolyte secondary battery
11 electrode assembly
12 positive electrode terminal
13 negative electrode terminal
14 outer can
15 sealing plate
16 injection member
17 gas release valve
20 positive electrode
21 positive electrode core
23, 33 core exposed portion
25 positive electrode current collector
30 negative electrode
31 negative electrode core
35 negative electrode current collector
40 separator

1. A non-aqueous electrolyte for a secondary battery, the non-aqueous electrolyte including a non-aqueous solvent, the non-aqueous electrolyte comprising:
a carboxylate ester; and
lithium bis (oxalato)borate,
wherein the concentration of the carboxylate ester is from 0.01% by volume to less than 10% by volume relative to the volume of the non-aqueous solvent, and
wherein the concentration of the lithium bis (oxalato)borate is from 0.01 M to less than 0.2 M.

2. The non-aqueous electrolyte for a secondary battery according to claim 1, wherein the carboxylate ester is a chain carboxylate ester.

3. The non-aqueous electrolyte for a secondary battery according to claim 2, wherein the carboxylate ester is at least one selected from methyl acetate, ethyl acetate, methyl propionate, and ethyl propionate.

4. A non-aqueous electrolyte secondary battery comprising:
the non-aqueous electrolyte for a secondary battery according to claim 1;
a positive electrode; and
a negative electrode.
